(19) United States
(12) Patent Application Publication
(10) Pub. No.: US 2026/0280163 A1
(43) Pub. Date: Sep. 17, 2026

(54) CONNECTOR AND METHOD OF USE WITHOUT PREATTACHED SOLDER BALL

(71) Applicant: Samtec, Inc., New Albany, IN (US)

(72) Inventors: Jacob L. Harris, New Albany, IN (US); James R. Huffman, New Albany, IN (US)

(21) Appl. No.: 19/168,661

(22) PCT Filed: Mar. 22, 2024
(86) PCT No.: PCT/US2024/021166

§ 371 Date: Sep. 24, 2025

Related U.S. Application Data
(60) Provisional application No. 63/492,033, filed on Mar. 24, 2023.
(60) Provisional application No. 63/508,737, filed on Jun. 16, 2023.
(60) Provisional application No. 63/547,608, filed on Nov. 7, 2023.

(51) Int. Cl. H01R 12/70; H01R 12/71; H01R 13/24; H01R 13/6461

(52) U.S. Cl. CPC H01R 12/707; H01R 12/7082; H01R 12/714; H01R 13/2471; H01R 13/6461

(57) ABSTRACT

An electrical connector comprising: at least three immediately consecutive, parallel, linear arrays of electrical conductors, each electrical conductor further comprising a SMT conductor tail that is devoid of a solder mass, wherein each SMT conductor tail is immediately adjacent to another SMT conductor tail.

### CROSS-REFERENCE TO PREVIOUS APPLICATIONS

This application claims priority from U.S. provisional patent application No. 63/492,033 filed on Mar. 24, 2023, U.S. provisional patent application No. 63/508,737 filed on Jun. 16, 2023, and U.S. provisional patent application No. 63/547,608 filed on Nov. 7, 2023, the entire contents of which are hereby incorporated herein by reference in its entirety.

### TECHNICAL FIELD

The present embodiments relate generally to surface mount technology, with particular embodiments shown for an electrical connector that does not have preattached solder balls.

### PROBLEMS WITH OTHER TECHNICAL APPROACHES

Unlike dual in-line or flat packages, ball grid array interconnects provide a greater number of interconnection conductors or contacts. A majority of a bottom surface of an interconnect body can be populated with a plurality of conductors or contacts, instead of just a perimeter of the interconnect body or housing.

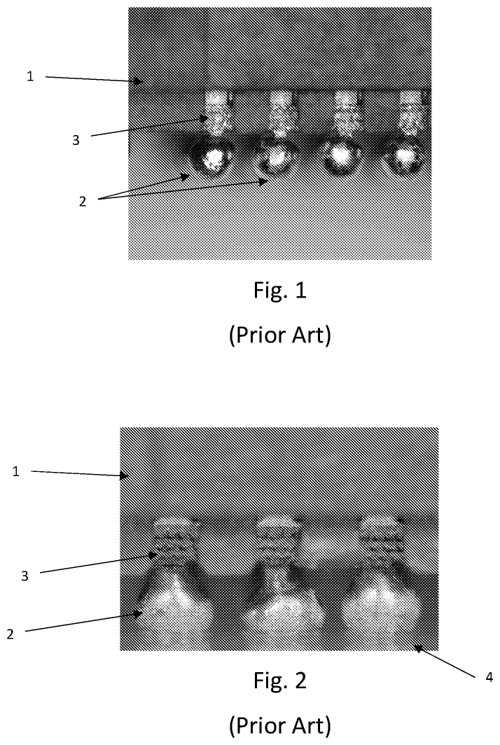

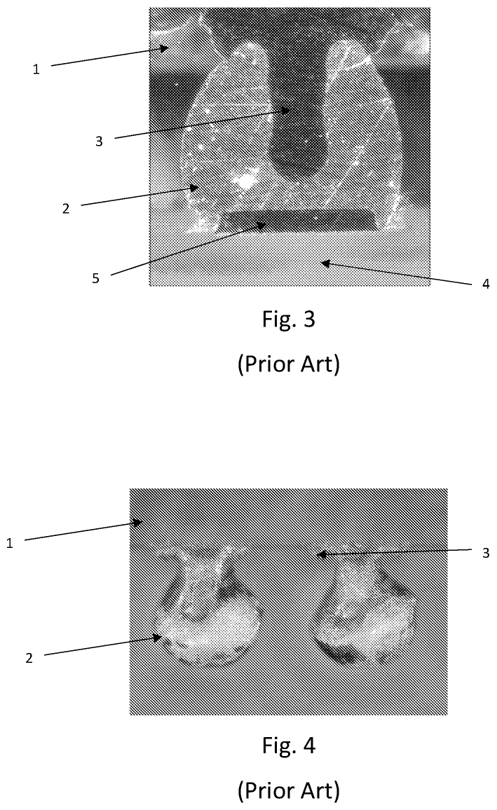

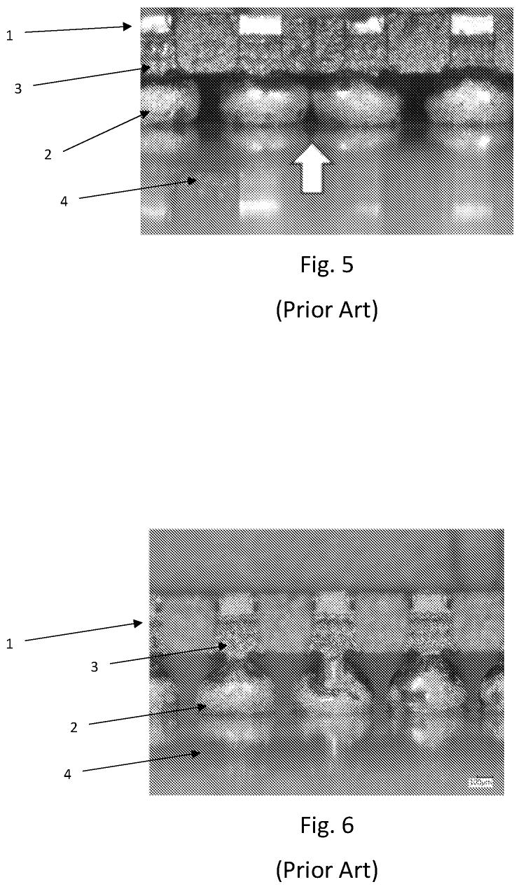

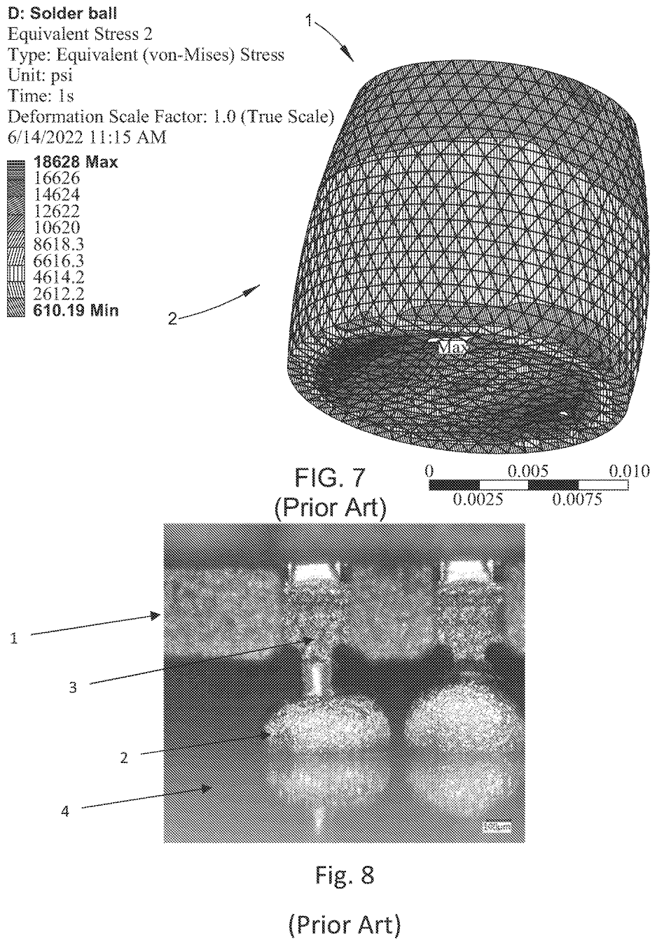

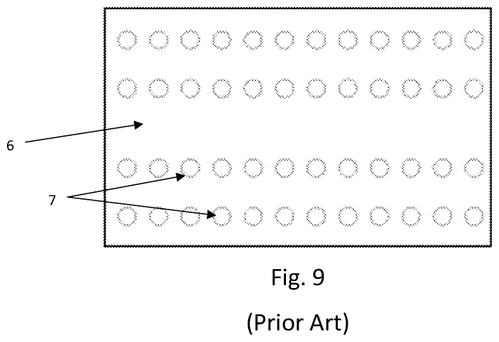

A shown in FIGS. 1-8, in one typical surface mount technology, a ball grid array interconnect, such as connector 1 includes a plurality of solder balls 2 preattached thereto. As shown in FIG. 1, the unprocessed connector 1 includes a plurality of electrical conductors 3, each conductor 3 including a preattached solder ball 2. As shown in FIG. 2 in a processed configuration, the conductors 3 with corresponding solder balls 2 are shown as reflowed and bonded to the board or substrate 4 (e.g. PCB). FIG. 3 illustrates the cross-section of the processed solder ball 2 between the conductor 3 and board 4 (e.g. pad 5). As a result of using solder balls 2 preattached to the conductor 3, the shape/attachment/signal strength may create issues with the structure/processes in the unprocessed solder balls 2 connected to the conductors 3 and/or processed solder balls 2 reflowed with the board 4. This may lead to a warped shape, flux residue, improper wetting, incorrect flux ratio, irregular coplanarity, high scrap rate, processing weights required for longer positioning of parts, inspection difficulties, customer quality problems, deformed solder balls, unreliable signal integrity performance, minimal clearance, poor visual appearance, and/or processing weights required for longer position parts. For example, FIG. 4 illustrates the unprocessed typical solder ball 2 deformed upon attachment to the conductor 3. Further, as shown in FIG. 5, the processed solder ball 2 may provide reduced minimum clearance and/or touching contact therebetween and be detrimental to the signal integrity. FIG. 6 illustrates the poor attachment of the processed typical solder ball 2 (e.g. the solder ball not coalescing upward or to the anti-wicking coating). FIG. 7 illustrates the poor shape of the convex outer periphery with corresponding reduced joint strength of the processed typical solder ball. FIG. 8 illustrates the poor wetting of the solder ball 2 use and/or undesirable head-in-pillow engagement of the processed typical solder ball 2. Further, FIG. 9 illustrates a typical solder ball stencil 6 with openings 7 for solder paste. A reduced amount of solder paste on the pads 5, via the stencil 6/openings 7, is used to process the solder ball 2, preattached to the conductors 3, to the board 4 (e.g. contacts, pads 5).

Further, typical usage of solder ball 2 technology was replaced by solder crimp technology (U.S. Pat. No. 7,837,522) for surface mount technology in some applications. However, as the density of electrical conductors increased per square millimeter or square centimeter, solder ball 2 and solder crimp technology usage become less desirable. U.S. Pat. Nos. 7,837,522; 6,945,796 and 6,558,170 and US Publication No. US20060228912 are hereby incorporated by reference in their entireties.

### SUMMARY

A technical problem to be solved is applying or reflowing or surface mounting a first article, such as an electrical interconnect or electrical connector or electrical component onto a respective substrate, such as a printed circuit board without creating any one or more of unwanted or commercially unacceptable electrical shorts, unwanted or commercially unacceptable electrical opens, and unwanted or commercially unacceptable mechanically fragile solder joints. The first article or electrical interconnect or electrical component or electrical connector can include at least sixteen, or at least twenty-four, or at least thirty-two, or greater than thirty-two surface mountable electrical conductors arranged in an array, in an open pin field array, or in at least four corresponding, parallel rows or columns or linear arrays.

Technical solutions described herein can be used to improve unwanted or commercially unacceptable electrical shorts, unwanted or commercially unacceptable electrical opens, and unwanted or commercially unacceptable mechanically fragile solder joints between a first article, such as, but not limited to, an electrical connector and a corresponding substrate or respective, corresponding substrate pads.

Technical solutions described herein can also improve one or more of the signal integrity of an electrical interconnect or electrical connector, increase square millimeter or square centimeter density of electrical conductors or electrical conductor mounting ends without the use of solder balls, solder crimps, solder charges, solder fillets, or solder masses, increase the strength/size ratio benefit, reduce labor costs, reduce material costs, reduce heat process (e.g. down to one heat process), improve the solder/flux ratio, increase the processable coplanarity of the, reduce electrical opens, reduce solder sheer failures due to coefficient of thermal expansion (CTE) mismatches between any one or more of an electrical interconnect or electrically non-conductive housing of an electrical interconnect, reduce or prevent head-in-pillow, reduce or prevent solder ball quality problems, and/or improve the visual appearance of a reflowed solder joint.

### BRIEF DESCRIPTION OF THE ILLUSTRATIONS

In the drawings, like reference characters generally refer to the same parts throughout the different views. Also, the drawings are not necessarily to scale, emphasis instead generally being placed upon illustrating the principles of the invention.

FIG. 1 is a side view of an unprocessed connector of the prior art illustrating conductors having a plurality of solder balls preattached thereto.

FIG. 2 is a side view of a processed connector of FIG. 1 illustrating the connector and board after reflow of the solder balls.

FIG. 3 is a sectional view of the processed connector and board of FIG. 2 through the conductor and solder ball reflow.

FIG. 4 is another side view of an unprocessed connector of FIG. 1 illustrating the solder balls deformed when combined to the conductors.

FIG. 5 is another side view of a processed connector of FIG. 2 illustrating the solder balls having a reduced minimum clearance between adjacent, reflowed solder balls.

FIG. 6 is another side view of a processed connector of FIG. 2 illustrating the solder balls having poor wetting and/or poor attachment of reflowed solder balls.

FIG. 7 is a perspective view of a processed conductor of FIG. 2 illustrating the outer spherical shape and/or poor shape of reflowed solder balls, and illustrating poor joint strength.

FIG. 8 is another side view of a processed connector of FIG. 2 illustrating the poor wetting of the solder ball use and/or the undesirable head-in-pillow engagement of the reflowed solder balls.

FIG. 9 is a top view of a stencil of the prior art used for solder paste for connecting the unprocessed connector, with solder ball, of FIG. 2 to the board/pad.

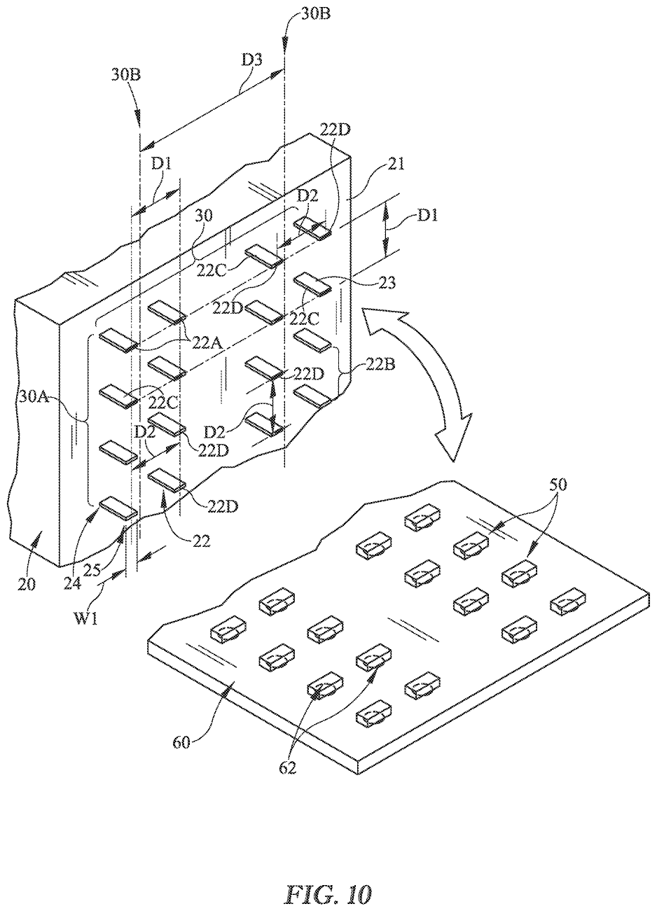

FIG. 10 is a perspective view of one embodiment of an unprocessed electrical connector, without the use of solder balls, exploded away from one embodiment of a board and/or pad, and illustrating the board/pad having solder paste thereon to reflow or process the unprocessed conductors of the electrical connector, void of solder balls.

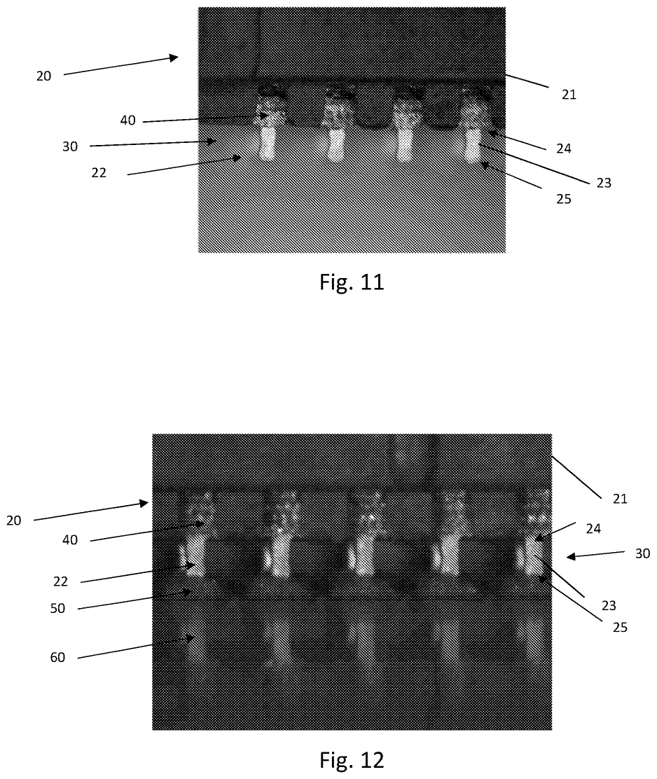

FIG. 11 is a side view of an unprocessed connector, without solder balls, of FIG. 10 illustrating conductors free of solder balls.

FIG. 12 is a side view of the unprocessed connector, without solder balls, of FIG. 11 illustrating the conductors contacting the solder paste on the board before reflow.

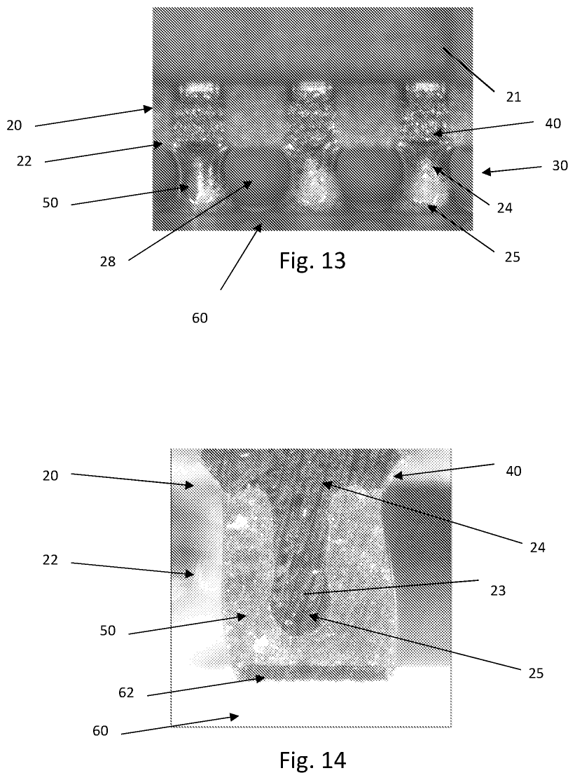

FIG. 13 is a side view of a processed connector of FIG. 11 illustrating the connector and board after reflow of the solder paste, without the use of solder balls.

FIG. 14 is a sectional view of the processed connector and board of FIG. 13 through the conductor and solder paste reflow, free of a solder ball.

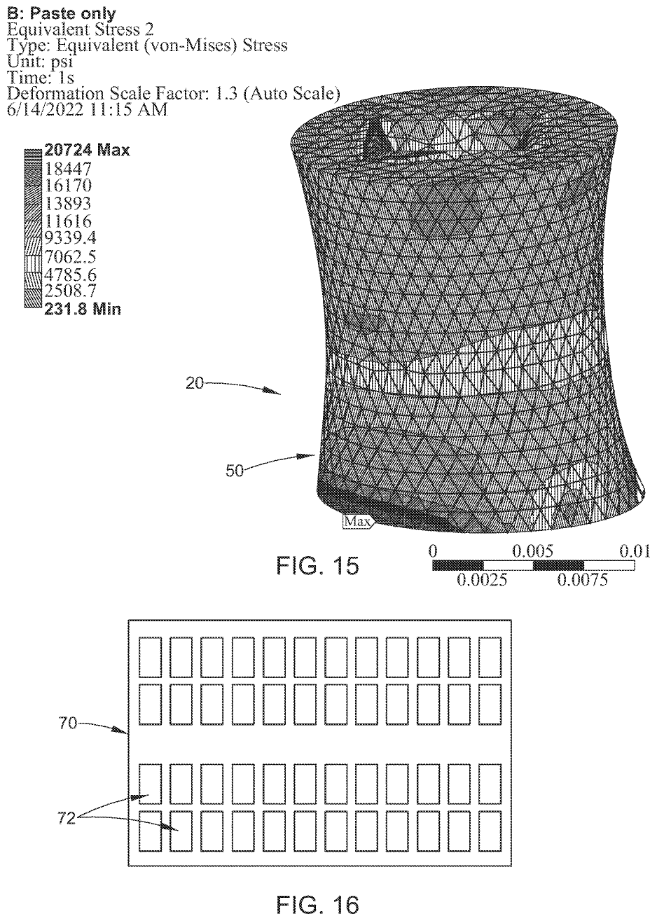

FIG. 15 is a perspective view of a processed conductor of FIG. 13, without the use of solder balls, illustrating the outer periphery having a column or hour glass shape of reflowed solder paste, and illustrating a better joint shape and/or equivalent to or greater strength than the joint strength of the conductor using solder balls of FIG. 7.

FIG. 16 is a top view of one embodiment of a stencil used for solder paste placement on the board/pad as shown in FIG. 10 for connecting the unprocessed connector, with no solder ball, of FIG. 11 to the board/pad.

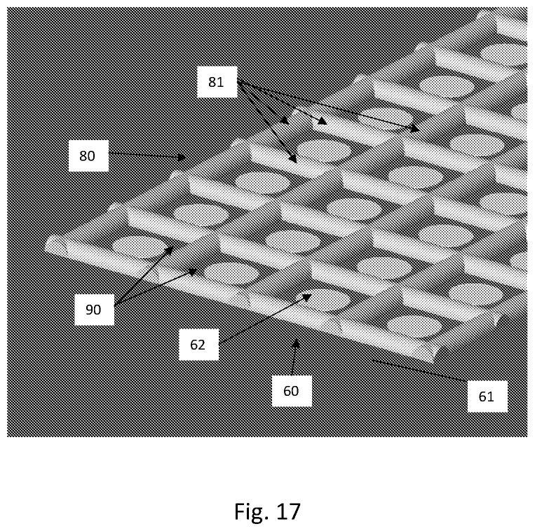

FIG. 17 is a top perspective of one embodiment of a grid structure, illustrating printing one or more walls on the substrate.

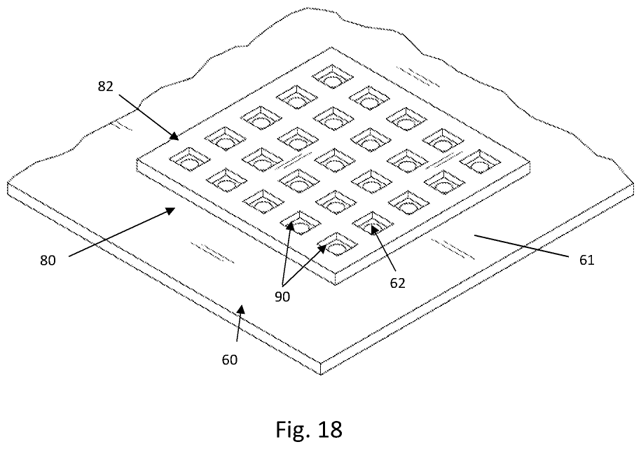

FIG. 18 is a top perspective of another embodiment of a grid structure, illustrating printing one or more layers on the substrate.

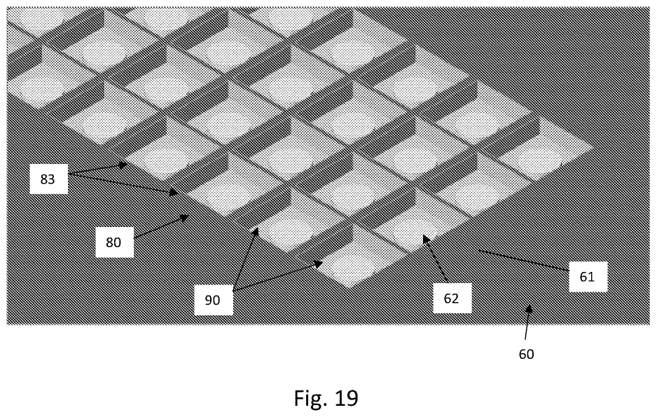

FIG. 19 is a top perspective of another embodiment of a grid structure, illustrating one or more recesses of the substrate.

### DETAILED DESCRIPTION

Embodiments may further be understood with reference to the various Figures. With reference to FIGS. 10-15, an embodiment provides an electrical connector 20, or portions thereof, without the use of the pre-attached solder balls or that are devoid of electrical conductors with a corresponding solder mass. Being devoid of a solder mass can mean that there is no solder present or carried by at least fifty percent of the respective electrical conductors 22 or respective conductor tails 23 prior to pick-and-placement of the electrical connector 22 onto a substrate 60. Being devoid of a solder mass can mean that there is no solder present or carried by at least fifty percent of the respective electrical conductors 22 or respective conductor tails 23 when the electrical connector 20 is packaged by the manufacturer of the electrical connector 20. Being devoid of a solder mass can mean that at least ten percent, at least twenty percent, at least thirty percent, at least forty percent, at least fifty percent, at least sixty percent, at least seventy percent, at least eighty percent, or at least ninety percent of the respective electrical conductors 22 or respective conductor tails 23 carry some mass of pre-attached solder, but not enough solder mass to reflow the respective electrical conductors 22 or respective conductor tails 23 onto a respective mating substrate 60 or respective substrate surface pad 62. Being devoid of a solder mass can mean that at least some or a majority of respective electrical conductors 22 or respective conductor tails 23 carry some mass of pre-attached solder, but not enough solder mass to reflow the respective electrical conductor 22 or respective electrical conductors 23 onto a respective mating substrate 60 or respective substrate surface pad 62. Being devoid of a solder mass can mean that at least half or at least sixteen of electrical conductors 22 or electrical tails 23 of an electrical component or electrical connector 20 carry some mass of pre-attached solder, but not enough solder mass to reflow the respective electrical conductor 22 or respective electrical conductors 23 onto a respective mating substrate 60 or respective substrate surface pad 62 without creating at least one of too many unwanted or commercially unacceptable electrical shorts, too many unwanted or commercially unacceptable electrical opens, and too many unwanted or commercially unacceptable mechanically fragile solder joints during thermal cycling of a plurality of respective solder joint formed between respective electrical conductors 22 or respective mating tails 23 and the respective mating substrate 60 or respective substrate surface pads 62. Commercially unacceptable can mean 0.05±0.05 percent, including greater than zero percent.

The electrical connector 20 can be a mezzanine connector, a right-angle connector, or a vertical connector. The electrical connector 20 can be a mezzanine array connector, a right-angle array connector or a vertical array connector. The electrical connector 20 can be a mezzanine open-pin-field array connector, a right-angle open-pin-field array connector or a vertical open-pin-field array connector. The electrical connector 20 can be a plug or a receptacle. The electrical connector 20 can be a cable connector. The electrical connector 20 can be an electrical SMT component. The electrical connector 20 may be configured to be soldered to a substrate without a respective fusible element, solder ball, solder slug, solder crimp, and/or solder slug positioned on the respective conductor or contact 22 (e.g. mounting end) prior to reflow. In the one embodiment shown in FIG. 10, the electrical connector 20 may include a plurality of conductors 22 in three or more arrays 30 without solder balls or without the conductors being processed/reflowed with solder balls/mass. As shown, an array 30, 30A can mean electrical conductors 22 that are arranged in a respective row or a respective column. An array 30, 30A can also mean that the electrical conductors 22 are arranged symmetrically on the electrical connector 20. An array can also mean that the totality of the electrical conductors 22 carried by the electrical connector, when viewed as a group, form a rectangular shaped or square shaped or parallelogram shaped or arcuate shaped perimeter. For example, the connector 20 shown in FIG. 10 includes four horizontal arrays 30, four vertical arrays 30A, or both, but may include at least three arrays 30, 30A, at least four arrays 30, 30A, at least five arrays 30, 30A, at least six arrays 30, 30A, at least seven arrays 30, 30A, or six or more arrays 30, 30A, wherein each array 30, 30A can include electrical conductors 22 that are arranged in a respective row or a respective column. As shown in the one embodiment, the arrays 30, 30A may be immediately consecutive, parallel, and/or linear. The arrays 30, 30A (e.g. at least three, four, five, six, six or more, etc.) may be immediately consecutive to each other. The arrays 30, 30A (e.g. at least three, four, five, six, six or more, etc.) may be parallel to each other. The arrays 30, 30A (e.g. at least three, four, five, six, six or more, etc.) may be in a linear pattern to each other. Each at least one electrical interconnect or electrical connector 20 can have at least three, at least four, more than three or more than four parallel, linear arrays 30, 30A. Each linear array 30 can contain at least four consecutive electrical conductors 22 arranged edge-to-edge along a respective first line in a repeating signal, ground S-G coaxial or single-ended configuration or in a repeating signal, signal, ground S-S-G or a repeating S-S-G-G differential pair signal configuration. Stated another way, each or at least one or at least two linear arrays 30 can contain edge coupled differential signal pairs 22A with optional interleaved ground conductors 22C. Each linear array 30A can contain at least four consecutive electrical conductors 22 arranged broadside-to-broadside along a respective second line in a repeating signal, ground S-G coaxial or single-ended configuration or signal, signal, ground S-S-G or S-S-G-G differential signal pair configuration. Stated another way, two immediately adjacent linear arrays 30A can, in combination, contain or form or define at least two broadside coupled differential signal pairs 22B, with optional interleaved ground conductors 22C. The combined immediately adjacent linear arrays 30A can define a third linear array 30B, with or without interleaved ground conductors 22C positioned between immediately adjacent third linear arrays 30B. Consecutive third linear arrays 30B can be spaced apart by a third distance D3, which can be any one of a first distance D1 or a second distance D2, as discussed below. The at least three, at least four, more than three or more than four parallel, linear arrays 30, 30A can each contain edge coupled or broadside coupled differential signal pairs 22A, 22B separated by at least one ground conductor 22C. The at least three, at least four, more than three or more than four parallel, linear arrays 30, 30A can be approximately evenly spaced apart by a respective row pitch, a column pitch or a first distance D1, such as any one or more of approximately 2±0.1 millimeters, approximately 1.8±0.5 millimeters, approximately 1.27±0.05 millimeters, approximately 1±0.09 millimeters, approximately 0.9±0.09 millimeters, approximately 0.8±0.09 millimeters, approximately 0.7±0.09 millimeters, approximately 0.6±0.09 millimeters, approximately 0.5±0.09 millimeters, approximately 0.4±0.09 millimeters, approximately 0.3±00.9, approximately 0.2±0.09 millimeters, and approximately 0.1±0.09 millimeters.

Each of the electrical conductors 22 in a respective at least three, at least four, more than three or more than four parallel, linear arrays 30, 30A can include a respective electrical conductor mounting end or mounting tail 23. Each mounting tail 23 can have a respective mounting end center 22D. A mounting end center 22D can be spaced apart from an immediately adjacent respective mounting end center 22D by a conductor pitch or second distance D2. Each respective second distance D2 can be approximately the same, mounting end center 22D to immediately adjacent mounting end center 22D, along a respective one of the parallel, linear arrays 30, 30A. Each respective second distance D2 can be the same or different, mounting end center 22D to immediately adjacent mounting end center 22D, along a respective one of the parallel, linear arrays 30, 30A. The second distance D2 can be any one or more of no greater than approximately 1.27±0.05 millimeters, no greater than approximately 1.2±0.05 millimeters, no greater than approximately 1±0.05 millimeters, no greater than approximately 0.9±0.09 millimeters, no greater than approximately 0.8±0.09 millimeters, no greater than approximately 0.7±0.09 millimeters, no greater than approximately 0.6±0.09 millimeters, no greater than approximately 0.5±0.09 millimeters, no greater than approximately 0.4±0.09 millimeters, no greater than approximately 0.3±0.09, no greater than approximately 0.2±0.09 millimeters, and no greater than approximately 0.1±0.09 millimeters.

Electrical conductor 22 widths W1 can vary, such as approximately 1±0.09 millimeters, 0.9±0.9 millimeters, 0.8±0.9 millimeters, 0.7±0.09 millimeters, 0.6±0.09 millimeters, 0.5±0.09 millimeters, 0.4±0.09 millimeters, 0.3±0.09 millimeters, 0.2±0.09 millimeters and 0.1±0.05 millimeters. Differential signal pairs can be spaced apart from another consecutive differential signal pairs or at least one interleaved ground contact or ground conductor 22C positioned consecutively between differential signal pairs by any first distance D1 or second distance D2 described above. An electrical connector 20 can be constructed using any first distance D1 mentioned above, in combination with any second distance D2 listed above, in combination with any electrical conductor 22 width W1 described above.

The term high-density is used differently in the interconnect industry, depending on the manufacturing company. Non-limiting examples of high-density electrical connectors 20 can include any of: (i) first, second, third and fourth consecutive, parallel, linear arrays 30. 30A of electrical conductors 22 spaced by a first distance D1 of approximately 1.27±0.05 millimeters, immediately adjacent electrical conductors 22 spaced apart, mounting end center 22D to immediately adjacent mounting end center 22D, by a second distance D2 of approximately 1.27±0.05 millimeters, and respective electrical conductor 22 widths W1 can be of any one of 0.6±0.05 millimeters, 0.5±0.05 mm, 0.4±0.05 mm, 0.03±0.05 mm, etc.; or (ii) first, second, third and fourth consecutive, parallel, linear arrays 30, 30A of electrical conductors spaced apart by a first distance D1 of approximately 1.25±0.05 millimeters, immediately adjacent electrical conductors 22 spaced apart, mounting end center 22D to immediately adjacent mounting end center 22D by a second distance D2 of approximately 0.8±0.5 millimeters, and respective electrical conductor 22 widths W1 of any one of 0.6±0.05 millimeters, 0.5±0.05 mm, 0.4±0.05 mm, 0.03±0.05 mm, etc.; or (iii) first, second, third and fourth consecutive, parallel, linear arrays 30, 30A electrical conductors 22 spaced by a first distance D1 of approximately 1.8±0.05 millimeters, immediately adjacent electrical conductors 22 spaced apart, mounting end center 22D to immediately adjacent mounting end center 22D, by a second distance of approximately 0.8±0.05 millimeters, and respective conductor 22 widths W1 of any one of 0.6±0.05 millimeters, 0.5±0.05 mm, 0.4±0.05 mm, 0.03±0.05 mm, etc. Any first distance D1, any respective second distance D2 and any respective electrical conductor 22 width W1 can be used in combination with one another. Any first distance D1, any respective second distance D2 and any respective electrical conductor 22 width W1 can be used in combination with one another to produce an electrical connector 20 with a differential, asynchronous, worst-case, multi-active crosstalk of six percent or less at differential signal frequency of at least 5 GHz (a corresponding data transfer speed of approximately 10 Gbits/sec). Any first distance D1, any respective second distance D2 and any respective electrical conductor 22 width W1 can be used in combination with one another to produce an electrical connector 20 with a differential, asynchronous, worst-case, multi-active crosstalk of six percent or less at differential signal frequency of at least 10 GHz or a data transfer speed of approximately 20 Gbits/sec. Any first distance D1, any respective second distance D2 and any respective electrical conductor 22 width W1 can be used in combination with one another to produce an electrical connector 20 with a differential, asynchronous, worst-case, multi-active crosstalk of six percent or less at differential signal frequency of at least 20 GHz or a corresponding data transfer speed of at least approximately 40 Gbits/sec. Any first distance D1, any respective second distance D2 and any respective electrical conductor 22 width W1 can be used in combination with one another to produce an electrical connector 20 with a differential, asynchronous, worst-case, multi-active crosstalk of six percent or less at differential signal frequency of at least 30 GHz or a corresponding data transfer speed of at least approximately 60 Gbits/sec. Any first distance D1, any respective second distance D2 and any respective electrical conductor 22 width W1 can be used in combination with one another to produce an electrical connector 20 with a differential, asynchronous, worst-case, multi-active crosstalk of six percent or less at differential signal frequency of at least 40 GHz or a corresponding data transfer speed of at least approximately 80 Gbits/sec.

High-density can also be defined by electrical conductor density or differential signal pair density. For example, the electrical connector 20 and/or arrays 30 (e.g. devoid of solder balls) may include an electrical conductor 22 density of at least 50 differential pairs of electrical conductors/contacts per square centimeter, at least 100 signal electrical conductors/contacts per square centimeter, and/or at least 150 signal and ground conductors/contacts per square centimeter. The electrical conductors (e.g. signal and/or ground) may have a variety of densities and still be within the scope of the invention. For example, at least eight conductors (e.g. 4 arrays/rows of 2 conductors per row, measured inside area is from conductor center to conductor center) may include, but is not limited to, a density of about 1 to about 7.7 square millimeters, about 1 to about 7.8 square millimeters, about 1.4 to about 4.3 square millimeters, about 1 to about 2 square millimeters, about 1 to about 3 square millimeters, about 1 to about 4 square millimeters, about 1 to about 5 square millimeters, about 1 to about 6 square millimeters, about 1 to about 7 square millimeters; about 1 to about 8 square millimeters; and/or about 1.1, 1.2, 1.3, 1.4, 1.5, 1.6, 1.7, 1.8, 1.9, 2, 2.1, 2.2, 2.3, 2.4, 2.5, . . . , 7.6, 7.7, 7.8, 7.9, and 8.0 square millimeters (e.g. 0.1 increments). Further for example, at least eight electrical conductors/contacts may be arranged in a configuration other than a circle or an ellipse (e.g. 4 arrays/rows of 2 conductors per row). An inside area defined by connecting the respective electrical conductive centers or respective mounting end centers 22D can be any area of approximately 1.3 square millimeters to approximately 4.4 square millimeters. Further for example, the electrical connector and/or arrays (e.g. devoid of solder balls) may include a density of at least one pair of differential pairs of electrical conductors/contacts per 1.4 mm by 1.4 mm, at least 2 signal conductors/contacts per 1.4 mm by 1.4 mm, and/or 3 signal and ground conductors/contacts per 1.4 mm by 1.4 mm. Further for example, the electrical connector and/or arrays (e.g. devoid of solder balls) may include a density of at least four pair of differential pairs of electrical conductors/contacts per 2.8 mm by 2.8 mm, at least 8 signal conductors/contacts per 2.8 mm by 2.8 mm, and/or 12 signal and ground conductors/contacts per 2.8 mm by 2.8 mm. Further for example, the electrical connector and/or arrays (e.g. devoid of solder balls) may include a density of at least sixteen pair of differential pairs of electrical conductors/contacts per 5.6 mm by 5.6 mm, at least 32 signal conductors/contacts per 5.6 mm by 5.6 mm, and/or 48 signal and ground conductors/contacts per 5.6 mm by 5.6 mm. Further for example, at least eight conductors/contacts (e.g. two rows with 2 pairs per row, devoid of solder balls) may include, but is not limited to, a density of about 2.5 square millimeters to about 4.5 square millimeters. Further for example, the electrical connector and/or arrays (e.g. devoid of solder balls) may include a density of at least four pair of differential pairs of electrical conductors/contacts per 3.62 square millimeters, at least 8 signal conductors/contacts per 3.62 square millimeters, and/or 12 signal and ground conductors/contacts per 3.62 square millimeters.

In some implementations, the electrical connector and/or arrays (e.g. devoid of solder balls) may include a density of at least four pair of differential pairs of electrical conductors/contacts per 2.772 square millimeters, at least eight signal conductors/contacts per 2.772 square millimeters, and/or 10 signal and ground conductors/contacts per 2.772 square millimeters. In some implementations, the electrical connector and/or arrays (e.g. devoid of solder balls) may include a density of at least four pair of differential pairs of electrical conductors/tails per 2.66 square millimeters, at least eight signal conductors/tails per 2.66 square millimeters, and/or 10 signal and ground conductors/tails per 2.66 square millimeters.

In some implementations, each conductor 22 may be or include a mounting end or conductor tail 23 (e.g. surface mount technology or SMT). The conductor tail 23 may be substantially linear, substantially straight, or in a single plane (e.g. planar) projecting from the housing or body 21 of the connector 20. Each respective mounting end or tail 23 may extend substantially perpendicular to the housing/board over a total respective length of the respective mounting end. Adjacent conductor tails 23 may be parallel to each other projecting from the connector body 21. Each mounting end or tail 23 may have a material thickness that lies parallel to a respective plane. The mounting end or tail 23 may not be bent out of its respective plane, may not be a press-fit pin, and/or may not be a J-lead. As shown in the one embodiment, each of the conductor tails 23 are immediately adjacent to each other within the array 30. Each of the conductor tails 23 would not be used with a solder ball before or after being processed. The conductors 22, or portions thereof, may include an anti-wicking barrier 40 on an outer periphery or surface area at an elevation adjacent a proximal end 24 and spaced away from the free distal end 25. The anti-wicking barrier 40, if used, may be configured to be a barrier to the solder paste 50. While the conductors 22 may be a variety of materials such as, but is not limited to, gold and silver, the anti-wicking barrier 40, if used, may be a variety of materials such as, but is not limited to, nickel. The conductor tails 23, or portions thereof, may include the barrier or anti-wicking barrier/coating 40 at the elevation to prevent or reduce upward reflow/coalescing/wicking of solder flux beyond the bottom extent of the anti-wicking barrier, rather than a solder ball.

In some implementations, the electrical connector 20, array(s) 30, and/or conductor(s) 22 are attached to the substrate/board 60 (e.g. PCB) without solder balls. The connector 20 via the conductors 22 are configured to be attached (e.g. soldered) to the substrate 60 (e.g. conductive pads) with reflowed solder paste 50, no solder ball. The mounting end or tail 23 may not penetrate into the substrate. The solder paste 50, board 60, and/or conductor 22/arrays 30 (e.g. unprocessed) is devoid of solder balls prior to reflow as shown in FIG. 12. Stated alternatively, only solder paste 50 is used to attach the connector 20 (e.g. conductor, distal end, at least three arrays) to the substrate 60/pads 62. The solder paste/flux 50 may be applied to the PCB or substrate 60 (e.g. pads 62) in sufficient quantities to be subsequently reflowed to attach/coalesce to the connector/conductors, without solder balls prior to reflow. Before reflow, the solder paste 50 (e.g. at least three arrays) may be positioned on the arrays (e.g. at least three arrays) of the conductive pads 62 as shown in FIG. 10. The arrays of solder paste 50 may be applied to the arrays of pads 62 or board 60 with the one embodiment of the stencil 70 as shown in FIG. 16. The solder paste 50 can coalesce from the distal end 25 towards the proximal end 24 of the conductor 22 (e.g. tail 23). The coalescing action of the solder paste 50 that can occur during reflow can fill in respective even or uneven gaps defined between material thickness edges or broadside mounting surfaces of respective conductors 22 or tails 23 and respective, corresponding pads 62. Using solder paste 50 as described herein can compensate for co-planarity variances along a mounting surface of the substrate 60, co-planarity variances along a mounting surface of the electrical connector 20, and can compensate for co-planarity variances between the mounting surface of the substate 60 and the mounting surface of the electrical connector 20. During reflow, the solder paste 50 may wick towards the proximal end 24 up to or adjacent the anti-wicking barrier 40, if used. The solder paste 50 may wick in direction against gravity. As shown in FIGS. 13-15, the processed attachment/joint of the solder paste 50 with the conductor 22, without the solder ball, provides an outer periphery with a column shaped periphery, an hour glass shaped periphery, or a concave periphery. The outer periphery may be a first configuration having a column or hour glass shape of reflowed/after-flow solder paste that is different from a second configuration of the solder paster prior to reflow. The processed conductor 22 (e.g. tail) and solder paste 50 without the solder ball is more of a column shape as shown in FIGS. 13-15 than the spherical cross-section of the processed conductor 3 using a solder ball 2 as shown in FIGS. 2, 3, and 5-8 of the prior art. As best shown in FIG. 13, the clearance or channel 28 between processed conductors 22/paste 50 may be defined as cylindrical in cross section defined by the adjacent reflowed solder paste 50. As shown in FIG. 15, the shape (e.g. hour glass) provided by the lack of the solder ball use provides for better joint strength as compared to when the solder ball 2 is used as shown in FIG. 7. The processed attachment/joint provides for consistent and/or minimum electrical clearance between the adjacent conductors 22 (e.g. tails)/paste 50 as shown in FIG. 13 and as compared to solder ball 2 use shown in FIG. 5 of the prior art. During reflow with the solder paste 50, the connector 20/conductor 22, without the solder ball, may not travel downwardly as far as the prior art connector 1/conductor 3 with preattached solder balls 2 does with gravity. Further, simulations of the processed connector 20/board 60 without solder ball use shows good or better signal integrity and equivalent strength (e.g. with less solder). For example in simulations, the insertion loss of the processed conductor 22 attachment with solder paste 50, without the solder ball, did not drop below −3 dB through 35 GHz while the prior art as shown in FIG. 2 dropped below −3 dB through 35 GHz.

In some implementations, the solder paste 50, or portions thereof, may be a variety of one or more materials such as, but is not limited to, leaded, unleaded, no clean, water soluble, non-water soluble, composites thereof, etc. The solder paste material may be of a variety of lead/alloy content, melting temperatures, alloy particle size, and/or tensile strength and still be within the scope of the invention.

In some implementations, the joint (e.g. solder paste) between the connector 22 and board 60, with no solder ball, may be configured to only a single heat process. Further, the process requires less stress while having a more predictable and/or stronger intermetallic bond. The processed joint between the connector and board may also include an optimum ideal solder/flux ratio. As compared to the 91% solder of the prior art joint using a solder ball, the joint without a solder ball includes 52% solder. The joint without a solder ball may also have increased wettability than with the solder ball usage of the prior art. The embodiments without solder balls may also have reduced quality problems as described herein.

In some implementations, the connector 20 and/or board 60 may include one or more stencils 70. The stencil 70 may be used or configured to place solder paste 50, or array of solder paste, onto the board 60 (e.g. pad, array of pads) as shown in FIG. 10. The amount/volume of solder paste used for the connector 20 and/or each conductor 22, without the use of the solder ball, may be larger than the solder paste used with the solder ball of the prior art. The stencil 70 may include a plurality of apertures or solder paste receiving holes 72. With the stencil 70 adjacent the substrate 60 and/or pads 62, the solder paste 50 is filled or positioned into the plurality of apertures 72 and the stencil is subsequently removed leaving the previously filled solder paste 50 on the board as shown in FIG. 10. The area of the apertures 72 of the stencil 70 may accommodate a sufficient volume (e.g. larger than with a solder ball) to coalesce up the conductor 22, void of the solder ball/mass. The area of the aperture may be increased to accommodate a large volume of solder paste received, when not using solder balls. For example, by adjusting the height of the stencil, shape of the aperture, and/or periphery dimensions defining the aperture in some embodiments. The conductor 22 or tail 23 may be positioned in the center of the solder paste 50 after the stencil is removed, as shown in FIG. 12. The array of apertures 72 of the stencil 70 may be a variety of shapes, sizes, quantities, and construction and still be within the scope of the invention. For example, in the one embodiment shown, the aperture may be rectangular in shape. In other embodiments, the shape may be different such as, but is not limited to, triangular. The footprint of the stencil may be similar to the stencil of the prior art in some embodiments.

In some implementations, the area of the solder paste receiving holes may be configured to receive a variety of volumes of the solder paste. For example, at least 3.342961e\hat{ }-5 cubic centimeters of solder paste (e.g. 0.004 inch stencil thickness and aperture size of 0.00051 square inches) per aperture. Further for example, at least 3.44128344e\hat{ }-5 cubic centimeters of solder paste (e.g. 0.005 inch stencil thickness and aperture size of 0.00042 square inches) per aperture. It should be understood that a variety of solder paste volumes and corresponding stencil/apertures may be used within the scope of the embodiments. For example, the solder past volume may be, but is not limited to, about 0.0000007 to about 0.000006 cubic inches, about 0.0000007 to about 0.000005 cubic inches, about 0.0000007 to about 0.000004 cubic inches, about 0.0000007 to about 0.000003 cubic inches, about 0.0000007 to about 0.000002 cubic inches, about 0.0000007 to about 0.000001 cubic inches, about 0.0000008 to about 0.000006 cubic inches, and/or about 0.0000008, 0.0000009, 0.000001, 0.000002, 0.000003, 0.000004, 0.000005, 0.000006 cubic inches. The following Table 1 illustrates some embodiments of the volume of solder paste tested and corresponding stencil configurations.

TABLE 1

| Aperture | Aperture | Stencil | |
|---|---|---|---|
| Width | Length | Thickness | Solder Paste Volume |
| (inches) | (inches) | (inches) | (cubic inches) |
| 0.012 | 0.017 | 0.004 | 0.00000082 |
| 0.010 | 0.028 | 0.004 | 0.00000112 |
| 0.008 | 0.042 | 0.004 | 0.00000134 |
| 0.015 | 0.030 | 0.004 | 0.00000180 |
| 0.015 | 0.030 | 0.005 | 0.00000225 |
| 0.015 | 0.030 | 0.006 | 0.00000270 |
| 0.016 | 0.030 | 0.006 | 0.00000288 |
| 0.015 | 0.040 | 0.005 | 0.00000300 |
| 0.015 | 0.050 | 0.005 | 0.00000375 |
| 0.015 | 0.070 | 0.005 | 0.00000525 |
| 0.013 | 0.026 | 0.005 | 0.00000169 |
| 0.017 | 0.03 | 0.005 | 0.00000255 |

In some implementations, as the density of solder paste increases, the solder paste receiving hole size may decrease and the material/stencil thickness may increase.

In some embodiments, an electrical connector may include at least three immediately consecutive, parallel, linear arrays of electrical conductors. In various embodiments, each electrical conductor may include a SMT conductor tail that is devoid of a solder mass. In some embodiments, each SMT conductor tail may be immediately adjacent to another SMT conductor tail.

In addition, in some embodiments, the electrical connector may include at least four arrays of electrical conductors. In various embodiments, the electrical connector may include at least five arrays of electrical conductors. In some embodiments, the electrical connector may include at least six arrays of electrical conductors. In various embodiments, the SMT conductor tail may include a distal end devoid of a solder mass. In some embodiments, the electrical connector may include a substrate, wherein the at least three arrays of electrical conductors connects to the substrate devoid of a solder mass. In various embodiments, the electrical connector may be attached to a substrate with reflowed solder paste and is devoid of solder balls prior to reflow. In some embodiments, the reflowed solder paste may be at least 3.342961e\hat{ }-5 cubic centimeters of solder paste adjacent each SMT conductor tail.

In some embodiments, a stencil may include a plurality of solder paste receiving holes. In various embodiments, each of the plurality of holes may have an area configured to receive at least 3.342961e\hat{ }-5 cubic centimeters of solder paste.

In addition, in some embodiments, each of the plurality of holes may have the area configured to receive at least 3.44128344e\hat{ }-5 cubic centimeters of solder paste.

In some embodiments, an electrical connector may include at least three parallel, consecutive linear arrays of electrical conductors. In some embodiments, the electrical connector may have a conductor density of at least 50 differential pairs of electrical conductors/contacts per square centimeter, at least 100 signal electrical conductors/contacts per square centimeter, and/or at least 150 signal and ground conductors/contacts per square centimeter, wherein the connector is attached to a substrate with reflowed solder paste and is devoid of solder balls prior to reflow.

In addition, in some embodiments, the electrical conductor may be a SMT conductive tail devoid of a solder ball immediately adjacent another SMT conductive tail devoid of a solder ball. In various embodiments, the electrical connector may include at least three immediately consecutive, parallel, linear arrays of the electrical conductors. IN some embodiments, the electrical connector may be attached to the substrate with reflowed solder paste and is devoid of solder balls prior to reflow, each conductor comprising at least 3.342961e\hat{ }-5 cubic centimeters of the reflowed solder paste to attach to the substrate.

In some embodiments, a method of processing an electrical connector without solder balls may include providing an electrical connector having at least three immediately consecutive, parallel, linear arrays of electrical conductors. In various embodiments, each electrical conductor may include a SMT conductor tail. In some embodiments, each SMT conductor tail may be immediately adjacent to another SMT conductor tail. In various embodiments, the method may include processing/soldering each SMT conductor tail devoid of a solder mass.

In addition, in some embodiments, the method may include filling solder paste in a plurality of solder paste receiving holes of a stencil. In various embodiments, each of the plurality of holes may have an area configured to receive at least 3.342961e\hat{ }-5 cubic centimeters of solder paste. In some embodiments, each of the plurality of holes may have the area configured to receive at least 3.44128344e\hat{ }-5 cubic centimeters of solder paste. In various embodiments, the method may include reflowing only solder paste to connect a substrate to each SMT conductor tail. In some embodiments, the method may include maintaining a minimum clearance between the processed SMT conductor tail. In various embodiments, the method may include maintaining a solder/flux ratio of 52% solder. In some embodiments, the method may include forming an hour glass shape of the processed SMT conductor tail. In various embodiments, the method may include maintaining an insertion loss above-3 dB through 35 GHz. In some embodiments, the method may include heating solely when processing each SMT conductor tail devoid of a solder mass.

In some embodiments, an electrical connector may include a plurality of conductors configured to connect to a substrate without a respective fusible element, solder ball, solder slug, solder crimp or solder slug positioned on the respective conductor prior to reflow.

In some embodiments, an electrical connector may include a housing and at least 4 parallel, consecutive, linear arrays of electrical conductors/contacts. In various embodiments, each electrical conductor may have a respective mounting end with a material thickness. In some embodiments, the material thickness of each respective mounting end may lie parallel to a respective plane. In various embodiments, each respective mounting end may not be bent out of its respective plane, each respective mounting end may not be a press-fit pin, and/or may not be a J-lead. In some embodiments, the electrical connector may be configured to be soldered to a substrate without a respective fusible element, solder ball, solder slug, solder crimp, and/or solder slug positioned on the respective mounting end prior to reflow.

In some embodiments, an electrical connector may include a housing and at least 4 parallel, consecutive, linear arrays of electrical conductors/contacts. In various embodiments, each electrical conductor may have a respective mounting end. In some embodiments, each respective mounting end may extend substantially perpendicular to the housing over a total respective length of the respective mounting end. In various embodiments, each respective mounting end may not be a press-fit pin, and may not be a J-lead. In some embodiments, the electrical connector may be configured to be soldered to a substrate without a respective fusible element, solder ball, solder slug, solder crimp and/or solder slug positioned on the respective mounting end prior to reflow.

In some embodiments, an electrical connector may include a housing and at least 4 parallel, consecutive, linear arrays of electrical conductors/contacts. In various embodiments, each electrical conductor may have a substantially straight mounting end that does not penetrate into a substrate. In some embodiments, each substantially straight mounting end may be devoid of a respective fusible element, solder ball, solder slug, solder crimp, and/or solder slug. In various embodiments, the electrical connector may be sold and/or offered for sale as an SMT connector.

In some embodiments, an electrical connector may include a housing and at least 4 linear arrays of electrical conductors/contacts. In various embodiments, each electrical conductor may have a substantially straight mounting end that does not penetrate into a substrate. In some embodiments, each substantially straight mounting end may be devoid of a respective fusible element, solder ball, solder slug, solder crimp, and/or solder slug. In various embodiments, the electrical connector may be reflowed to a substrate.

In some embodiments, an electrical connector may include a housing and at least 6 parallel, consecutive, linear arrays of electrical conductors. In various embodiments, each electrical conductor may have a substantially straight mounting end that does not penetrate into a substrate. In some embodiments, the electrical connector may be configured to be soldered to a substrate.

In some embodiments, an electrical connector may include a housing and 7 or more parallel, consecutive, linear arrays of electrical conductors. In various embodiments, each electrical conductor may have a substantially straight mounting end that does not penetrate into a substrate. In some embodiments, the electrical connector may be configured to be soldered to a substrate.

In some embodiments, an electrical connector may include a housing and at least 8 electrical conductors/contacts arranged in a configuration other than a circle or an ellipse. In various embodiments, each of the 8 electrical conductors/contacts may have a respective center. In some embodiments, an inside area defined by connecting the respective centers may be approximately 1.3 square millimeters to approximately 4.4 square millimeters. In various embodiments, each electrical conductor may have a substantially straight mounting end that does not penetrate into a substrate. In some embodiments, each substantially straight mounting end may be devoid of a respective fusible element, solder ball, solder slug, solder crimp, and/or solder slug. In various embodiments, the electrical connector may be reflowed to a substrate.

In some implementations, a grid or matrix structure 80 (e.g. material(s)), or portions thereof, may be defined by the substrate 60 and/or printed/deposited upon the substrate 60 or electrical connector 22 (e.g. one or more surfaces 61), or portions thereof, to define/form one or more containment areas/volumes 90. The grid 80 (e.g. walls, layers, etc.), or portions thereof, may be printed by a variety of methods such as, but is not limited to, 3D printing, silkscreen printing, mask printing, or aerosol printing. The grid 80 (e.g. recesses, etc.), or portions thereof, may be defined/formed in the substrate 60. The grid 80, or portions thereof, may provide containment of one or more materials (e.g. paste 50). The grid 80 may contain one or more materials in one or more targeted or confined or containment areas/volumes 90 (e.g. adjacent pads). The grid 80 may be built/deposited upwardly from the substrate 60 or surface 61 in one or more layers/increments/levels. The grid may narrow or enlarge the periphery of the area 90 in a direction away from the surface 61. The grid or boundary/periphery formed/deposited on the substrate/surface may reduce the chance of bridging, increase the effective solder stencil thickness, decrease minimum pitch/row-to-row, and/or reduce cross-talk to benefit signal integrity. For example, the row-to-row dimension of the pads/container areas may be reduced to about 0.4 millimeters to about 0.4 millimeters. Further for example, the conductor center-to-center spacing may be approximately 0.003 inches.

In some implementations, the connector 20 or grid 80, or portions thereof, may include one or more walls 81 surrounding or defining the areas/surfaces/volumes 90 (e.g. inner periphery, outer periphery), or portions thereof, on the substrate 60 or surface 61. For example, the deposited walls 81 (e.g. one wall, two walls, three walls, four walls, . . . , 6 walls, more than one wall, etc.) of the grid 80 may surround or at least partially surround or define an area/surface/volume 90 (e.g. containment) on/adjacent the substrate 60 or pad 62 (e.g. PCB) as shown in the one embodiment in FIG. 17. The grid or structure 80 (e.g. 81, 82, 83) may maintain or keep the solder paste 50 or material in the confined area, pre-flow in some embodiments. The raised/deposited grid 80 (e.g. walls 81) may be silkscreen printed or 3D printed or aerosol printed in some embodiments.

In some implementations, the connector 20 or grid 80, or portions thereof, may include a plurality of layers 82 (e.g. mask) surrounding or defining the areas/surfaces/volumes 90, or portions thereof, on the substrate 60 or surface 61 to define/form one or more containment areas/volumes 90. The mask layer(s) 82 on the substrate 60 or surface 61 or surface area is deposited/printed except for or defining the containment areas 90 for which to maintain the material therein. The layer 82 may mask one or more surfaces 61 of the substrate 60 or connector 20 to define the area adjacent the pads 62 as shown in the one embodiment in FIG. 18. The raised or deposited grid 80 (e.g. layer 82) may be a soldermask in some embodiments.

In some implementations, the connector 20, substrate 60, and/or grid or matrix structure 80 (e.g. material(s)) may include one or more recesses 83 to define/form one or more containment areas/volumes 90. As shown in the one embodiment in FIG. 19, the substrate 60 may include one or more recesses 83 therein. The recess 83 may depend from the substrate surface 61 (e.g. top surface). The one or more substrate surfaces 61 may define a variety of openings of the recess 83. The one or more recesses 83 may be defined by or depend/project (e.g. for a depth) into the body of the substrate 60. The one or more recesses 83 may include one or more conductive pads 62 positioned therein. For example, the pad 62 may be in the bottom wall of the recess 83. The recesses 83 may create wells or containers or a containment area/volume/surface 90 for containing material (e.g. paste, etc.) therein. For example, solder paste 50 (e.g. pre-flow) may be retained in the one or more recesses 83 within the substrate 60. Although the one or more recesses 83 are shown without the wall 81 or layers 82 or grid structure above the surface 61, it should be understood that the grid (e.g. layer(s), wall(s)) may be used in combination with the one or more recesses and still be within the scope of the invention.

Although the grid/walls/layer(s)/recesses/containment area(s) is shown in the Figures, it should be understood that a variety of shapes, sizes, quantities, and constructions may be used and still be within the scope of the invention. The grid may remain on the substrate/surface or may be removed therefrom. For example, solvent or physically removal may be used to remove one or more portions of the grid structure. Further, for example, the area or periphery of the area 90 may be arcuate in shape rather than rectangular in shape as shown in the one embodiment. Although the area 90 is shown as being surrounded 360 degrees by the wall/layer/grid/recess, the periphery may be partially surrounded or less than 360 degrees. The containment areas 90 may be similar or different from each other (e.g. height, shape, size, volume, spacing, patterns, etc.). The grid, or portions thereof, walls or peripheral surfaces of the area 90 may be angled or perpendicular to the surface 61 as shown in the one embodiment. The walls or peripheral surfaces of the area 90 include overhangs or lateral projections.

In some implementations, the grid/recess/wall/layer, or portions thereof, may contain the one or more materials (e.g. solder paste) pre-reflow in some embodiments.

In some implementations, the grid, or portions thereof, may be a variety of one or more materials such as, but is not limited to, polymers, ink, not water based, water based, metal, ceramic, lubricant, composites thereof, etc. The grid material may be a lubricant or contain a lubricant. The one or more materials may be removeable from the substrate or surface(s) or remain therewith. The walls, recesses, and/or layers may be a variety of thicknesses/heights/widths/patterns and still contain material therein.

In some implementations, the grid 80 (e.g. walls, recesses, layers) may be used in combination with one or more stencils 70. The stencil 70, if used, may include a plurality of apertures 72. The one or more apertures 72 of the stencil 70 may be positioned adjacent to or on top of the one or more containment areas 90 of the grid 80. The aperture(s) may be in fluid communication with the area(s) when adjacent thereto. The adjacent aperture 72 (e.g. first volume) of the stencil and containment areas 90 (e.g. second volume) combine to provide a combined area/volume/thickness (e.g. third volume) to receive/contain one or more materials therein. In some embodiments, a single stencil 70 may be used with a plurality of grids/substrates having a variety of thickness/areas/volumes to vary the overall/combined thickness/volume/area of the material contained/defined by the combined grid area and stencil aperture. The stencil may also have a varied material thickness across the area/plane of the stencil. For example, the stencil apertures may be of different volumes/sizes/shapes in a variety of patterns/locations across the plane of the stencil. In some implementations, a step stencil may not be needed with the use of the grid, or portions thereof.

In some implementations, the material contained within the aperture 72 and/or containment area 90 may be a variety of materials such as, but is not limited to, solder paste/flux 50.

In some implementations, the volume of the solder paste may be increased with the grid and the stencil, if used. Further, the use of the increased amount of solder paste may be in close proximity (e.g. decreased row-to-row dimension) to each other when contained by the grid and the stencil, if used.

In some implementations, the use of the grid or substrate or connector, or portions thereof, (e.g. wall, layer, recess) may decrease the wicking of the contained material therein.

In use, the grid 80 (e.g. wall(s) 81, layer(s) 82) may be printed on the substrate/connector surfaces in a variety of patterns, shapes, sizes, quantities, and constructions. The substrate 60 may have one or more recesses 83, if used. Alternatively, in some embodiments, recesses may be used rather than the grid structure printed thereon. The one or more stencils 70, if used, may be positioned on the wall/layer/substrate/recess/connector. The aperture(s) 72, or portions thereof, of the stencil 70 may align or be positioned adjacent corresponding containment areas 90 of the grid/recesses/wall/layer. In some embodiments, solder paste 50 may be received or applied to the combined aperture 72 and containment areas 90. The stencil, if used, may be subsequently removed. In some embodiments, the grid (e.g. walls, layers), or portions thereof, may be removed or maintained on the substrate.

In some embodiments, a substrate may include a plurality of parallel, linear arrays of pads. In various embodiments, the substrate may include a grid structure projecting from one or more surfaces of the substrate to form one or more containment areas adjacent each pad of the plurality of pads.

In addition, in some embodiments, the grid structure may include one or more walls defining the one or more containment areas. In various embodiments, the grid structure may include a layer defining the one or more containment areas. In some embodiments, the grid structure may be removable from the one or more surfaces of the substrate. In various embodiments, the grid structure may remain on the one or more surfaces of the substrate. In some embodiments, the substrate may include one or more recesses defining at least a portion of the containment areas and/or having the pad positioned therein. In various embodiments, the grid structure may be printed by 3D printing or silkscreen printing or mask printing or aerosol printing. In some embodiments, the substrate may include solder paste contained within the one or more containment areas. In various embodiments, the substrate may include an electrical connector having a plurality of conductors configured to connect to the substrate without a respective fusible element, solder ball, solder slug, solder crimp or solder slug positioned on the respective conductor prior to reflow. In some embodiments, the substrate may be in combination with a stencil having a plurality of apertures, wherein the plurality of apertures connect in fluid communication with the one or more containment areas to receive one or more materials. In various embodiments, the plurality of pads may have a row-to-row dimension of about 0.4 millimeters to about 0.4 millimeters.

In some embodiments, a method of processing an electrical connector without solder balls may include providing an electrical connector having at least three immediately consecutive, parallel, linear arrays of electrical conductors, each electrical conductor further comprising a SMT conductor tail, wherein each SMT conductor tail may be immediately adjacent to another SMT conductor tail. In various embodiments, the method may include printing a grid structure on one or more surfaces of a substrate to form one or more containment areas adjacent each pad of a plurality of pads. In some embodiments, the method may include processing each SMT conductor tail devoid of a solder mass.

In addition, in some embodiments, the method may include containing a solder paste within the one or more containment areas. In various embodiments, the method may include positioning a stencil adjacent the grid structure. In some embodiments, the stencil may include a plurality of apertures, and wherein the apertures is adjacent the one or more containment areas. In various embodiments, the grid structure may be at least one wall. In some embodiments, the grid structure may be at least one layer.

In some embodiments, a substrate may include a plurality of recesses within a surface of the substrate. In various embodiments, the substrate may include a plurality of parallel, linear arrays of pads positioned in the plurality of recesses. In some embodiments, the plurality of recesses may define one or more containment areas for containing one or more materials.

In addition, in various embodiments, the substrate may include a connector. In some embodiments, the substrate may include a stencil. In various embodiments, the grid structure may include one or more walls. In some embodiments, the grid structure may include one or more layers.

In some embodiments, an electrical connector may include a means for reflowing solder paste devoid of a solder mass. In various embodiments, the means for reflowing solder paste is in at least three immediately consecutive, parallel, linear arrays of electrical conductors. In some embodiments, each electrical conductor may include a SMT conductor tail that is devoid of a solder mass. In various embodiments, each SMT conductor tail may be immediately adjacent to another SMT conductor tail.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

Means plus function disclosure and claims presented in means plus function format are hereby expressly interpreted under 35 U.S.C. § 112(f). Applicant expressly makes no admissions, either expressly or implied, by exercising its statutory rights to describe and submit one or more claims in 35 U.S.C. § 112(f) permitted format. Any limitations read in to a means plus function disclosure or a means plus function claim or claims recited (i) in this application, (ii) any applications that claim the benefit of this application, or any claims filed outside the United States.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

1. An electrical connector comprising:
at least three immediately consecutive, parallel, linear arrays of electrical conductors, each electrical conductor further comprising a SMT conductor tail that is configured to attach to a substrate with reflowed solder paste and is devoid of a solder mass prior to reflow, wherein each SMT conductor tail is immediately adjacent to another SMT conductor tail.

2. The electrical connector of claim 1 comprising at least four arrays of electrical conductors.

3. The electrical connector of claim 1 comprising at least five arrays of electrical conductors.

4. The electrical connector of claim 1 comprising at least six arrays of electrical conductors.

5. The electrical connector of claim 1 wherein the SMT conductor tail includes a distal end devoid of a solder mass.

6. The electrical connector of claim 1 further comprising a substrate, wherein the at least three arrays of electrical conductors connects to the substrate devoid of a solder mass.

7. The electrical connector of claim 6 is attached to a substrate with reflowed solder paste from a plurality of pads of the substrate.

8. The electrical connector of claim 7 wherein the reflowed solder paste is at least 3.342961e\hat{ }-5 cubic centimeters of solder paste adjacent each SMT conductor tail.

9. (canceled)

10. (canceled)

11. The electrical connector of claim 1 further having conductor density of at least 50 differential pairs of electrical conductors/contacts per square centimeter, at least 100 signal electrical conductors/contacts per square centimeter, and/or at least 150 signal and ground conductors/contacts per square centimeter.

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. An electrical connector comprising: a plurality of conductors configured to connect to a substrate without a respective fusible element, solder ball, solder slug, solder crimp or solder slug positioned on the respective conductor prior to reflow from one or more pads of the substrate.

25. An electrical connector comprising:
a housing and at least 4 parallel, consecutive, linear arrays of electrical conductors (or contacts), wherein each electrical conductor has a respective mounting end with a material thickness, the material thickness of each respective mounting end lies parallel to a respective plane, each respective mounting end is not bent out of its respective plane, each respective mounting end is not a press-fit pin, and is not a J-lead, and the electrical connector is configured to be soldered to one or more pads of a substrate with reflowed solder paste without a respective fusible element, solder ball, solder slug, solder crimp or solder slug positioned on the respective mounting end prior to reflow.

26. The electrical connector of claim 24 further including a housing and at least 4 parallel, consecutive, linear arrays of the plurality of electrical conductors, wherein each electrical conductor has a respective mounting end, each respective mounting end extends substantially perpendicular to the housing over a total respective length of the respective mounting end, each respective mounting end is not a press-fit pin and is not a J-lead.

27. The electrical connector of claim 24 is sold or offered for sale as an SMT connector.

28. The electrical connector of claim 24:
wherein each electrical conductor has a substantially straight mounting end that does not penetrate into a substrate.

29. The electrical connector of claim 24 further including
a housing and at least 6 parallel, consecutive, linear arrays of the plurality of electrical conductors, wherein each electrical conductor has a substantially straight mounting end that does not penetrate into a substrate.

30. The electrical connector of claim 24 further including
a housing and 7 or more parallel, consecutive, linear arrays of the plurality of electrical conductors, wherein each electrical conductor has a substantially straight mounting end that does not penetrate into a substrate.

31. The electrical connector of claim 24 further including
a housing and at least 8 electrical conductors arranged in a configuration other than a circle or an ellipse, each of the 8 electrical conductors has a respective center, an inside area defined by connecting the respective centers is approximately 1.3 square millimeters to approximately 4.4 square millimeters, each electrical conductor has a substantially straight mounting end that does not penetrate into a substrate.

32. The electrical connector of claim 7 further comprising
a grid structure projecting from one or more surfaces of the substrate to form one or more containment areas adjacent each pad of the plurality of pads.

33. The electrical connector of claim 32 wherein the grid structure includes one or more walls defining the one or more containment areas.

34. The electrical connector of claim 32 wherein the grid structure includes a layer defining the one or more containment areas.

35. The electrical connector of claim 32 wherein the grid structure is removable from the one or more surfaces of the substrate.

36. The electrical connector of claim 32 wherein the grid structure remains on the one or more surfaces of the substrate.

37. The electrical connector of claim 32 wherein the substrate further comprises one or more recesses defining at least a portion of the containment areas and having the pad positioned therein.

38. The electrical connector of claim 32 wherein the grid structure is printed by 3D printing or silkscreen printing or mask printing or aerosol printing.

39. The electrical connector of claim 32 further comprising solder paste contained within the one or more containment areas.

40. (canceled)

41. The electrical connector of claim 32 in combination with a stencil having a plurality of apertures, wherein the plurality of apertures connect in fluid communication with the one or more containment areas to receive one or more materials.

42. The electrical connector of claim 32 wherein the plurality of pads have a row-to-row dimension of about 0.4 millimeters to about 0.4 millimeters.

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. An electrical connector comprising:
a means for reflowing solder paste in at least three immediately consecutive, parallel, linear arrays of electrical conductors from one or more pads of a substrate, wherein each electrical conductor further comprising a SMT conductor tail that is devoid of a solder mass prior to reflow, wherein each SMT conductor tail is immediately adjacent to another SMT conductor tail.
